(19) United States
(12) Patent Application Publication
(10) Pub. No.: US 2025/0192583 A1
(43) Pub. Date: Jun. 12, 2025

(54) CHARGING STATION, HAIR CLIPPER AND ADAPTER FOR THE SAME

(71) Applicant: WAHL GMBH, St. Georgen (DE)

(72) Inventor: Ralf DOTTER, St. Georgen (DE)

(21) Appl. No.: 18/846,523

(22) PCT Filed: Mar. 17, 2023
(86) PCT No.: PCT/EP2023/056962

§ 371 Date: Sep. 12, 2024

(30) Foreign Application Priority Data
Mar. 17, 2022 (EP) 22162762.3

(51) Int. Cl. H02J 7/00; A45D 27/29; B26B 19/38

(52) U.S. Cl. CPC H02J 7/0045; A45D 27/29; B26B 19/3873

(57) ABSTRACT

A charging station is disclosed for charging a battery device in a hair clipper, including a main body and a connection device for electrically connecting the hair clipper to the charging station wherein the connection device has two contact elements and a magnetic, in particular permanent-magnetic, or magnetically reactive retaining element.

### FIELD OF THE INVENTION

The invention relates to a charging station for charging a battery device in a hair clipper, an adapter for adapting of a plug contact of a hair clipper, a hair clipper and a combination of such charging station and such hair clipper.

### STATE OF THE ART

There are different electric hair clippers that vary in size depending on their intended use—from small trimmers to shavers to large hair clippers for the main hair. Some of these also have differently configured electrical contact elements.

In hairdressing salons, a variety of different electric hair clippers are usually used. To ensure that they are always ready for use, their battery devices must be charged constantly, at least to a large extent. As a result, a large number of different charging stations are used in hairdressing salons, many of which are also configured specifically for the device. On the one hand, this means that a large part of the work surface is filled with charging stations and, on the other hand, the hairdresser has to go to the matching charging station after using a hair clipper in order to be able to put the hair clipper down correctly. In some cases, if the hairdresser cannot immediately find the appropriate charging station or if it is not immediately accessible to him, the hair clipper is stored on any free space on the work surface, which can result in the hair clipper not being found later, not being charged and thus not being usable, or even being thrown down because it was overlooked during the sometimes fast-paced hairdressing routine. In addition, due to the form-fitting plugs, the hair clipper and charging station often have to be plugged together very precisely so that the corresponding contacts are also securely connected to each other.

### REPRESENTATION OF THE INVENTION

It is therefore the problem of the present invention to enable the user to store a variety of different hair clippers in a simple and safe manner in an easily accessible and matching charging station.

The problem is solved by a charging station according to claim 1, an adapter according to claim 3, a hair clipper according to claim 4 and a combination of such a charging station and such a hair clipper according to claim 12. Further features of the invention are defined in the dependent claims.

A charging station for charging a battery device in a hair clipper according to the invention comprises a main body and a connection device for electrically connecting the hair clipper to the charging station and is characterised in that the connection device has two contact elements and a magnetic, in particular permanent-magnetic, or magnetically reactive retaining element. The connection device can be arranged in the main body. The main body can be designed as a storage unit for the hair clipper and can itself be stored on a surface, e.g. on feet. The main body can also be a power supply unit that can be plugged directly into a socket and then be connected to the connection device via a cable. The two contact elements of the charging station are designed to provide an electrical contact between the connection device of the charging station and the hair clipper and thus to charge the battery device of the hair clipper. With such a hair clipper, it is possible to easily connect the electrical contacts of the hair clipper and a corresponding charging station, because the magnetic or magnetically reactive retaining elements push the hair clipper into a predetermined orientation.

The retaining element is configured in such a way that it is either itself a magnet or has such a magnet, i.e. it is magnetic or consists of a magnetically reactive material or has such a magnetically reactive material. The retaining element can be an electromagnet or have such a magnet or, in particular, be a permanent magnet or have such a permanent magnet. The permanent magnet can have different shapes, in particular a disc magnet, a bar magnet, a cuboid magnet, a spherical magnet, a ring magnet, a cone magnet, a pot magnet, a magnetic tape or a magnetic foil. The magnetically reactive material may in particular be or comprise a magnetisable material, such as a magnetisable ferromagnetic material (for example iron, cobalt or nickel). The magnetically reactive material can also be a diamagnetic or paramagnetic material. The retaining element is preferably circular, but may also have a quadrangular, pentagonal, hexagonal or other polygonal shape. Furthermore, the retaining element can have an irregular or non-rotationally symmetrical contour (e.g. U-shaped), so that it is in complete contact with another retaining element in only one predetermined alignment with the complete contact surfaces. Thus, reverse polarity protection of the contact elements can also be achieved.

Preferably, the main body has a bearing area for placing or setting aside the hair clipper. This enables secure positioning of the hair clipper. According to the invention, placing the hair clipper on the charging station means in particular placing it on one of its longitudinally oriented surfaces as well as placing it on its base, i.e. on the side of the connection device.

Preferably, the charging station further comprises a cover plate configured and arranged to at least partially cover the bearing area. In this way, the charging station can be protected from dirt, which increases its durability. Furthermore, the appearance of the surface can be improved, e.g. with different patterns or logos. In another embodiment, the cover plate can have a greater material thickness, e.g. 2 cm, 3 cm, 4 cm or more, on at least one side and thus act as a support.

Preferably, the cover plate is also designed to be replaceable. This simplifies the removal and cleaning of a dirty cover plate from the charging station. Furthermore, it is possible to use differently designed cover plates, for example differently coloured cover plates, in order to simplify the assignment to specific users or cover plates provided with company logos, in order to increase the value of the charging station perceived by the consumer or customer.

Preferably, the charging station also has a connection housing, said connection housing being configured and arranged in such a way that the connection device of the charging station is rotatably and linearly displaceably mounted therein. Preferably, in the charging state—the hair clipper is connected to the charging station—the hair clipper is stored on the bearing area.

This way, the charging station can be used for hair clippers with different housing geometry, this means with different distances between the connection devices of the hair clippers to the bearing area as well as different angular orientations of the connection devices of the hair clippers to the bearing area in the state of the put down hair clipper.

This can be done by positioning the connection device of the charging station according to the required angular orientation and the required distance.

Preferably, the charging station further comprising at least one supporting element for supporting the hair clipper. Thus, the hair clipper can be supported in such a way that the force acting on the connection device, in particular the force acting on the contact elements, is minimised.

The supporting element can be configured in such a way that it holds or supports the hair clipper in the immediate vicinity of the connection device. In addition, the supporting element can be configured in such a way that it exerts its supporting or holding effect on the hair clipper distant from the connection device.

Furthermore, two or more supporting elements can be provided. Thus, it can be achieved that different hair clippers with different housing geometries can be supported securely.

Preferably, the supporting element is also designed in such a way that the supporting element acts on the hair clipper away from the handling area of the hair clipper, for example in the foot or head area of the hair clipper. Thus, it is possible to put down and pick up the hair clipper as easily as possible.

The supporting element can be configured as a leaning element, configured in such a way that the hair clipper can be leaned against it. The supporting element can also be configured as a positioning pin. A positioning pin is particularly a very space-saving supporting element.

Preferably, the supporting element is reversibly connected to the charging station. In this way, if necessary—e.g. if a hair clipper with a different housing geometry is to be electrically charged with the charging station—a suitable supporting element can be used quickly and easily. This increases the variability of the charging station.

Preferably, the bearing area is configured to be tiltable. In this way, by tilting the bearing area, hair clippers with different housing geometries connected to the charging station for electrical charging can be tilted in such a way that they are securely supported by the supporting element or lean securely against the leaning element. This increases the variability of the charging station.

Preferably, the supporting element configured as a positioning pin is built into the connection device. Thus, a small assembly space and at the same time a high supporting effect can be achieved.

Preferably, a connection device complementary to the connection device with the positioning pin has a positioning recess which is configured in such a way that it can receive the positioning pin. Thus, a high support effect can be achieved and the hair clipper can be precisely aligned at the same time.

Preferably, the charging station has a status display which is designed in such a way that it can be used to indicate to the user that a hair clipper is correctly connected to the charging station so that the battery device of the hair clipper can be electrically charged. In this way, reverse polarity protection can be provided for the hair clipper, so that the hair clipper can be electrically charged in the stored or parked state and a faulty connection of the contact elements is avoided.

Preferably, the status display is further configured in such a way that the charging status of the battery device of the hair clipper can be indicated. In this way, the user of the hair clipper can be informed whether the hair clipper is ready for use or when it will be ready for use, which improves usability.

Preferably, the charging station further comprises a battery device. Thus, it is possible to charge the charging station itself, so that electrical wiring on the user's work surface can be omitted. This improves the usability of the charging station.

Preferably, the battery device of the charging station has a greater electrical capacity than the battery device of the hair clipper. This makes it possible to charge several battery devices of the hair clippers or one battery device of a hair clipper several times within one charging cycle of the battery device of the charging station. This increases the possible operating time of the hair clippers in a simple way.

An adapter for adapting of a plug contact of a hair clipper according to the invention comprises a main body with a plug device, configured to connect the adapter to a connection device of a hair clipper and a connection device, which can be contacted with a connection device of a charging station, wherein the connection device comprises two contact elements and a magnetic, in particular permanent-magnetic, or magnetically reactive retaining element. Thus, it is possible to retrofit a hair clipper with an inexpensive and easy-to-use adapter so that it can be used with a charging station according to the invention.

The two contact elements of the adapter are suitable for establishing an electrical contact between the connection device of the charging station and the hair clipper via the main body of the adapter in such a way that the battery device of the hair clipper can be charged with electrical current via electrical contact or connection elements further provided in the hair clipper and/or in the adapter.

A hair clipper according to the invention comprises a blade arrangement for cutting, a drive unit, which drives the blade arrangement, a battery device, which supplies electrical power to the drive unit and a connection device, which is electrically connected to the battery device and which can be contacted to the connection device of a charging station for charging the battery device, wherein the connection device comprises two contact elements and a magnetic, in particular permanent-magnetic, or magnetically reactive retaining element.

The two contact elements of the hair clipper are configured for providing an electrical contact between the connection device of the charging station and the hair clipper in such a way that the battery device of the hair clipper can be charged with electrical current via electrical contact or connection elements further provided in the hair clipper.

Preferably, the connection device of the charging station, the adapter or the hair clipper comprises an inwardly curved recess or an outwardly curved projection. Thus, in addition to the holding effect of the retaining elements generated by the magnetic effect, a holding effect generated by form fit is also generated. Thus, a more secure hold of the hair clipper in the charging station is provided.

Preferably, the recess and the projection are configured complementary to each other. They are further configured in such a way that they or the charging station, the adapter and/or the hair clipper, which comprise the recess and the projection, respectively, can be pivoted against each other. The pivotability can also be realised by means of a guide pin and/or a guide groove. Thus, it is possible to use a variety of different hair clippers with different housing geometries with a single charging station in a safe manner.

Preferably, the recess and the projection are each semi-cylindrical, whereby the radius of the semi-cylindrical recess is essentially as large as the radius of the semi-cylindrical projection. This allows a high degree of pivotability and thus a high variability with regard to the different housing geometries of the hair clippers.

Preferably, the two contact elements of the charging station, the adapter or the hair clipper together with the at least one retaining element completely cover the recess or the projection. Thus, a secure electrical contact and a high holding force can be achieved, due to a contact area that is as large as possible.

Preferably, at least one of the two contact elements of the charging station, the adapter or the hair clipper is configured as a contact projection, a contact recess and/or a contact strip. Thus, a secure contact is possible even when using different hair clippers with one and the same charging station.

Preferably, the contact element formed as a contact projection has a pin shape and has in particular a length of 3 mm or less, particularly preferably of 2 mm or less and most preferably of 1.5 mm or less.

Preferably, the contact element configured as a contact projection is also configured as a receding, springy contact projection. For this purpose, a spring element can also be provided in the contact element. Thus, a safe electrical contact can be achieved with a safe magnetic holding effect at the same time.

Preferably, the contact element configured as a contact strip is provided inside the inwardly curved recess or on the outwardly curved projection along the pivoting radius over the entire recess/projection. Thus, it is possible to maintain a secure electrical contact even when the hair clipper is pivoted in relation to the charging station.

Preferably, the charging station, the adapter or the hair clipper comprise/s at least two retaining elements being, in particular magnetically oppositely polarised. In this way, correct electrical contacting can be ensured during operation, with only one single storage position of the hair clipper on the charging station existing due to the retaining elements being magnetically active with different poles. This improves operational safety and simplifies handling.

Preferably, at least one of the two contact elements of the charging station, the adapter or the hair clipper is configured as magnetic retaining element or the retaining element is positioned adjacent to the contact element. Thus, a reduced assembly space of the connection device is enabled. Thus, the production costs can be reduced and also the required space on the user's work surface can be reduced, which in turn improves the usability.

Preferably, the at least one retaining element and/or the two contact elements of the charging station, the adapter or the hair clipper comprise/s a round, in particular circular, or striped contact area. Thus, a simple positioning of the hair clipper, which may have an adapter, on the charging station is enabled, whereby the usability is improved.

Preferably, the contact elements of the charging station, the adapter or the hair clipper are configured with different form-fit. Thus, it is enabled to additionally ensure geometrically via a form fit that no incorrect electrical contacting takes place, whereby the service life of the components is increased. Another type of reverse polarity protection can also be provided by an asymmetrical arrangement of the contact elements.

A combination of a charging station as above mentioned, a hair clipper as above mentioned or a hair clipper comprising an adapter as above mentioned, according to the invention, wherein the connection devices are configured complementary to one another, in particular also with respect to the magnetic retaining elements. Thus, an easy handling of the above mentioned charging station in combination with the above mentioned hair clipper is made possible.

Preferably, the mutually complementary configuration of the magnetic retaining elements is such that one magnetic retaining element has a north pole at the contact area to the other magnetic retaining element and the other magnetic retaining element has a south pole at its contact area to the one magnetic retaining element.

### BRIEF DESCRIPTION OF THE FIGURES

FIG. 1a displays a connection device comprising an outwardly curved projection, two retaining elements with a circular contact area and two contact elements in the form of a contact strip.

FIG. 1b displays a connection device complementary to the connection device displayed in FIG. 1a, comprising an inwardly curved recess, two retaining elements with a circular contact area and two contact elements configured as a contact projection.

FIG. 1c displays the connection devices displayed in FIGS. 1a and 1b, which are engaged with each other in a pivoted state.

FIG. 1d displays a connection device similar to the connection device displayed in FIG. 1a with a retaining element arranged centrally on the projection.

FIG. 1e shows the plug of a charging station that can be plugged into a connection device of an adapter or a hair clipper.

FIG. 1f displays a connection device for an adapter or hair clipper that is complementary to the connector.

FIG. 2a displays a connection device similar to the connection device displayed in FIG. 1a, comprising two retaining elements with a striped contact area.

FIG. 2b displays a connection device complementary to the connection device displayed in FIG. 2a, which is also similar to the connection device displayed in FIG. 1b, comprising two retaining elements with a striped contact area.

FIG. 2c displays a connection device similar to the connection device displayed in FIG. 2a, comprising two retaining elements in the form of disc magnets.

FIG. 3a displays a connection device similar to those displayed in FIGS. 1a, 2a and 2c, wherein the two contact elements in the form of a contact strip together with the retaining element completely cover the projection.

FIG. 3b displays a connection device complementary to the connection device displayed in FIG. 3a, wherein the two contact elements configured as contact projections together with the retaining element completely cover the recess.

FIG. 4a displays a connection device with a positioning recess.

FIG. 4b displays a connection device that is complementary to the connection device displayed in FIG. 4a and has a positioning pin.

FIG. 5a displays a charging station with a supporting element configured as a leaning element.

FIG. 5b displays a combination of the charging station displayed in FIG. 5a with a tilted bearing area on which a hair clipper is stored.

FIG. 6a displays a charging station with a supporting element configured as a positioning pin.

FIG. 6b displays the charging station displayed in FIG. 6a, on which a hair clipper is stored.

FIG. 6c displays a charging station similar to the charging station displayed in FIG. 6a, with a retaining element configured as a ring magnet.

FIG. 7a displays a combination of a charging station comprising a connection housing, into which a connection device is integrated, and a stored hair clipper.

FIG. 7b displays the connection housing and the integrated connection device of the charging station displayed in FIG. 7a.

FIG. 8 displays an exploded view of a combination of a hair clipper, an adapter and a charging station comprising a cover plate.

FIG. 9a displays a charging station with a connection device comprising a projection.

FIG. 9b displays a lower part of a hair clipper usable with the charging station displayed in FIG. 9a, with a connection device having a recess.

FIG. 10a displays a combination of a hair clipper with two contact elements configured as contact projections and a charging station with two contact elements configured as contact strips and a status display in the state immediately before the hair clipper is stored.

FIG. 10b displays the combination of a hair clipper and a charging station displayed in FIG. 10a in the state of the stored hair clipper.

FIG. 10c displays a combination of a hair clipper and a charging station similar to the combination of a hair clipper and a charging station displayed in FIGS. 10a and 10b, comprising a plurality of retaining elements positioned adjacent to the contact strip of the charging station and acting to magnetically repel the retaining elements of the hair clipper.

FIG. 11 displays a combination of a hair clipper and a charging station with a status display and a battery device.

### DESCRIPTION OF THE PREFERRED EMBODIMENTS

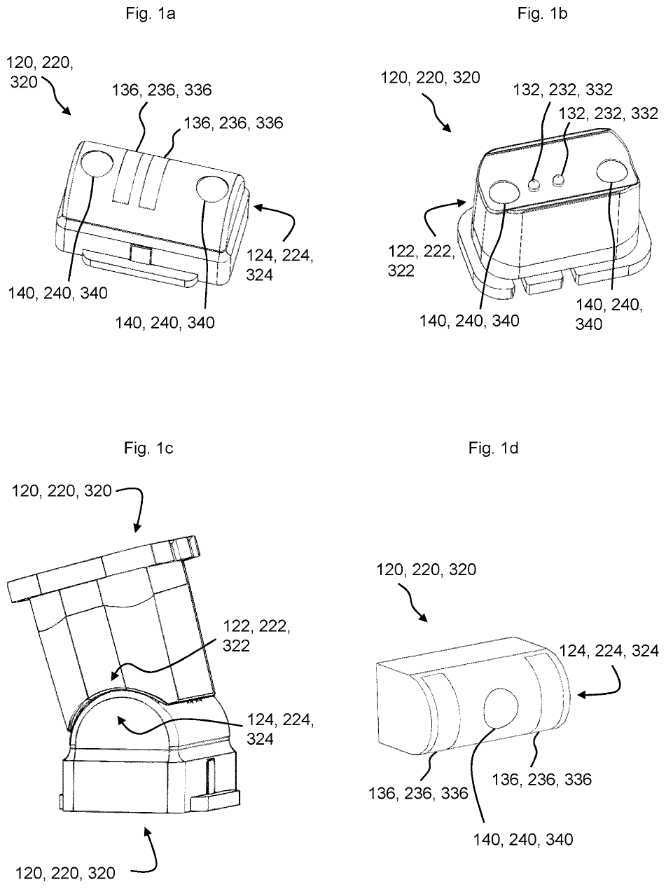

In the following, only the preferred embodiments of the connection devices 120, 220, 320 of the charging station 100, the adapter 200 and the hair clipper 300 are described. This means that the recesses 122, 222, 322 and the projections 124, 224, 324, the contact elements 130, 136, 230, 236, 330, 336 and the contact projections 132, 232, 332, and also the respective holding elements 140, 240, 340 can be interchanged in each case. One specific case is explicitly described following FIGS. 1a and 1b, but this also applies to all other pairings of the connection devices 120, 220, 320.

FIG. 1a displays a connection device 120, 220, 320 comprising an outwardly curved projection 124, 224, 324, two retaining elements 140, 240, 340 with a circular contact area and two contact elements in the form of a contact strip 136, 236, 336.

FIG. 1b displays a connection device 120, 220, 320 complementary to the connection device 120, 220, 320 displayed in FIG. 1a, comprising an inwardly curved recess 122, 222, 322, two retaining elements 140, 240, 340 with a circular contact area and two contact elements configured as a contact projection 132, 232, 332.

The connection device 120, 220, 320 displayed in FIG. 1a can be engaged with the connection device 120, 220, 320 displayed in FIG. 1b (see FIG. 1c) in such a way that the retaining elements 140, 240, 340 arranged on the projection 124, 224, 324 contact the retaining elements 140, 240, 340 arranged in the recess 122, 222, 322. Furthermore, the contact strips 136, 236, 336 are then also in contact with the contact protrusions 132, 232, 332. Here, it is displayed that the projection 124, 224, 324 in FIG. 1a has the contact strip 136, 236, 336 and the recess 122, 222, 322 has the contact projections or contact pins 132, 232, 332. However, it is also possible that the contact projections 132, 232, 332 are provided on the projection 124, 224, 324 and the contact strips 136, 236, 336 are provided in the recess 122, 222, 322. It is also possible that the contact projections 132, 232, 332 are striped and the circular contact elements are aligned with the surface of the projection 124, 224, 324 or the recess 122, 222, 322. As mentioned above, this also applies to all other embodiments.

The connection devices 120, 220, 320 displayed in FIG. 1c, which are in engagement with each other, are in a pivoted state. Due to the contact strips 136, 236, 336 arranged along a large part of the pivoting radius, there is electrical contact between the two connection devices 120, 220, 320 at a plurality of pivoting angles by means of the contact strips 136, 236, 336 of the connection device 120, 220, 320 displayed in FIG. 1a and the contact projections 122, 222, 322 of the connection device 120, 220, 320 displayed in FIG. 1b.

FIG. 1d displays a connection device 120, 220, 320 similar to the connection device 120, 220, 320 displayed in FIG. 1a with a retaining element 140, 240, 340 arranged centrally on the projection 124, 224, 324. Compared to the connection device 120, 220, 320 displayed in FIG. 1a, the contact strips 136, 236, 336 of the connection device 120, 220, 320 displayed in FIG. 1d are arranged at the outer edges of the projections 124, 224, 324.

FIG. 1e displays a connection device 120 configured as a plug. Such a plug is usually used with a charging device that is configured as a power supply unit. This means that the charging device itself can be provided with a conventional plug for a conventional socket, which is plugged into a socket. The charging device is connected to the connection device 120, which is designed as a plug, via a cable. A projection 124 is then formed on the connection device 120, in which the retaining elements 140 and the contact elements 130 are configured. The contact elements 130 and the retaining elements 140 are circular at the contact points. However, they can also be striped. Furthermore, the arrangement of the contact elements 130 is preferably asymmetrical, so that reverse polarity protection is provided in that not all contact elements 130 can be connected to each other if the plug is inserted upside down. In addition, a positioning pin 154 can be provided, which is also arranged asymmetrically (i.e. not in the centre here). This ensures that the connector can only be inserted in a predetermined orientation.

FIG. 1f displays the counterpart, i.e. the connection device complementary to the embodiment in FIG. 1e, which is provided here for an adapter or for a hair clipper. This has the complementary contact elements 232, 332 and retaining elements 240, 340. Furthermore, a positioning recess 226, 326 can also be formed to receive the positioning pin 154. Again, the plug of the charging station in the form of a power supply unit can be formed with a recess and the adapter or hair clipper can then have the projection 124.

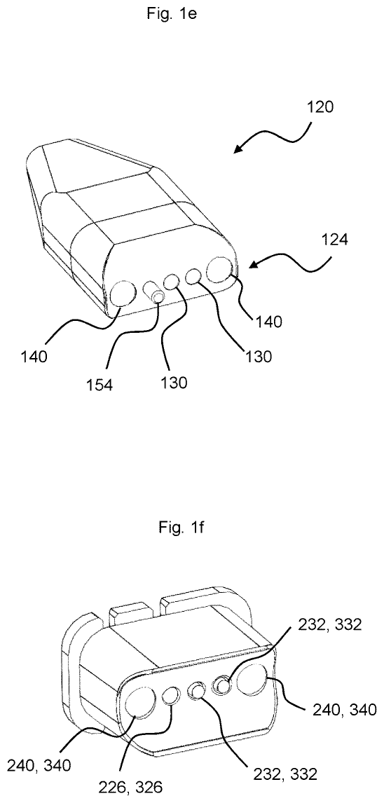

FIG. 2a displays a connection device 120, 220, 320 similar to the connection device 120, 220, 320 displayed in FIG. 1a, comprising two retaining elements 140, 240, 340 with a striped contact area. If such a connection device 120, 220, 320 is engaged with a connection device 120, 220, 320 as displayed in FIG. 2b—which also has striped retaining elements 140, 240, 340—a large number of pivoting angles can be used to ensure that the retaining elements 140, 240, 340 of the two connection devices 120, 220, 320 contact each other.

FIG. 2c displays a connection device 120, 220, 320 similar to the connection device 120, 220, 320 displayed in FIG. 2a, comprising two retaining elements 140, 240, 340 in the form of disc magnets. Compared to the connection device 120, 220, 320 displayed in FIG. 2a, which has striped retaining elements 140, 240, 340, a higher retaining force can be generated due to the greater magnetic effect of the disc magnets.

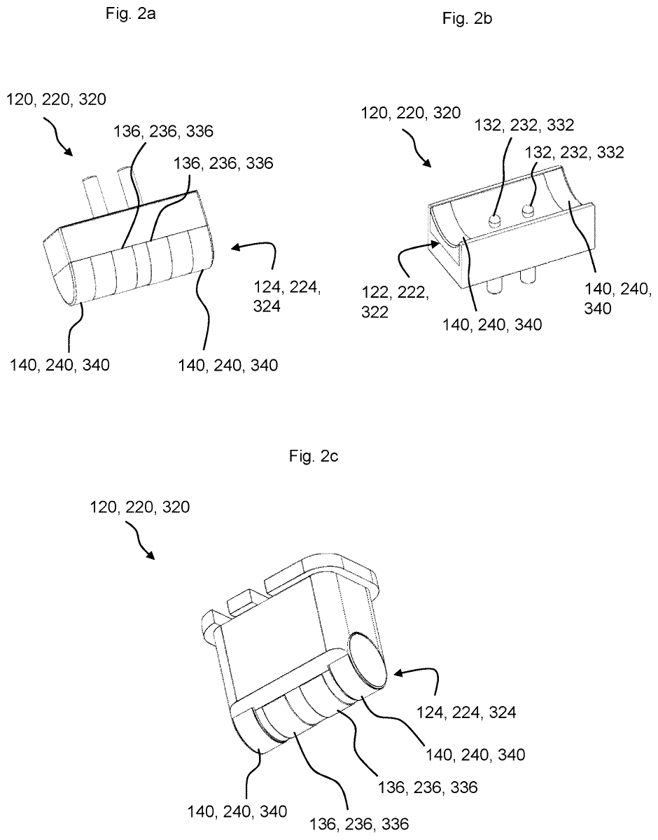

FIG. 3a displays a connection device 120, 220, 320 similar to those displayed in FIGS. 1a, 2a and 2c, wherein the two contact elements in the form of a contact strip 136, 236, 336 together with the retaining element 140, 240, 340 completely cover the projection 124, 224, 324. As also displayed in FIGS. 1a and 2a, the contact strips 136, 236, 336 are shaped comparatively narrow, while the retaining element 140, 240, 340 completely surrounds the contact strips 136, 236, 336 and accordingly covers a large part of the contact area that is formed during engagement with a further connection device 120, 220, 320. Thus, a very high magnetic effect and thus a very high holding force can be generated.

FIG. 3b displays a connection device 120, 220, 320 complementary to the connection device 120, 220, 320 displayed in FIG. 3a, wherein the two contact elements configured as contact projections 132, 232, 332 together with the retaining element 140, 240, 340 completely cover the recess 122, 222, 322. If a connection device 120, 220, 320 as displayed in FIG. 3b is combined with a connection device 120, 220, 320 as displayed in FIG. 3a, a very high magnetic effect and thus a very high holding force can be obtained.

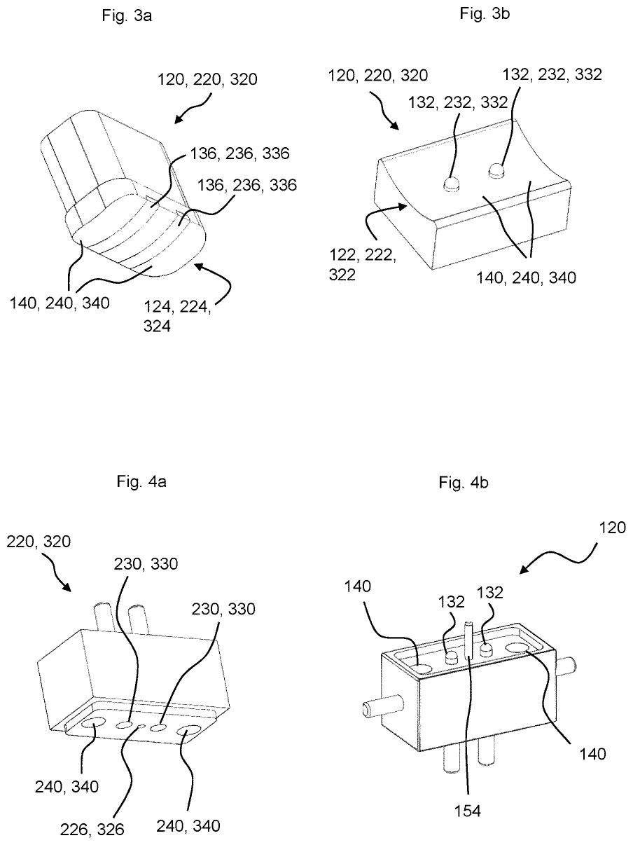

FIG. 4a displays a connection device 120, 220, 320 with a positioning recess 226, 326 and FIG. 4b displays a connection device 120, 220, 320 that is complementary to the connection device 120, 220, 320 displayed in FIG. 4a and has a positioning pin 154. If the connection device 120, 220, 320 displayed in FIG. 4a and the connection device 120, 220, 320 displayed in FIG. 4b are engaged with each other, the positioning pin 154 slides into the positioning recess 226, 326. This creates a supporting effect, which is enhanced by the retaining elements 140, 240, 340, and also ensures that the contact elements 130, 230, 330 are in electrical contact with the contact projections 132, 232, 332.

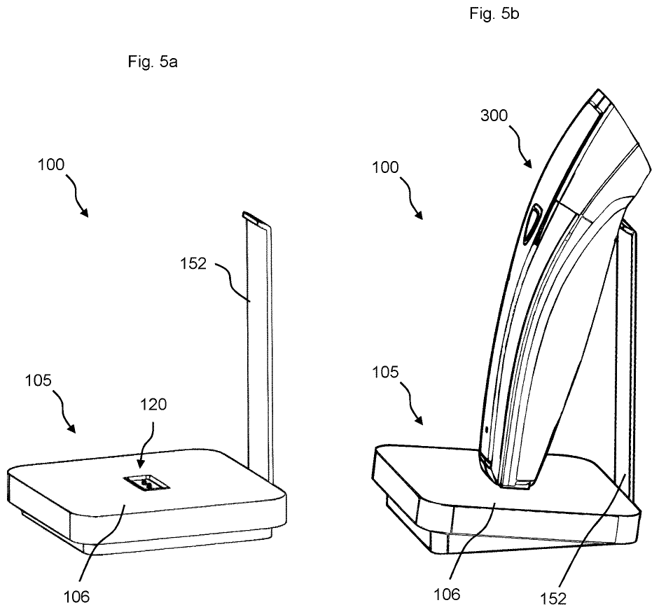

FIG. 5a displays a charging station 100 with a supporting element configured as a leaning element 152 and FIG. 5b displays a combination of the charging station 100 displayed in FIG. 5a with a tilted bearing area 106 on which a hair clipper 300 is stored. The hair clipper 300 displayed in FIG. 5b is electrically connected to the connection device 120. The bearing area 106 is tilted for safe storage of the hair clipper 300—as displayed in FIG. 5b—so that the hair clipper 300 touches the leaning element 152 and is supported by it.

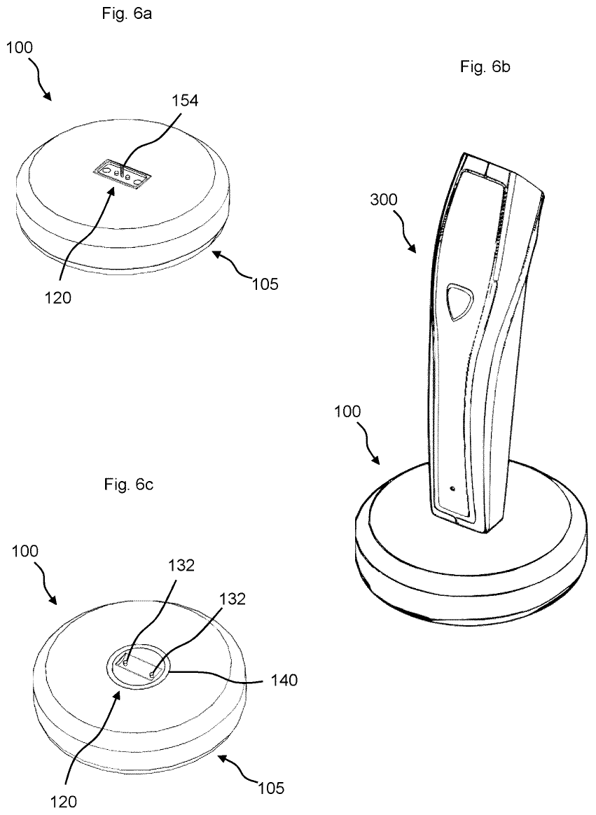

FIG. 6a displays a charging station 100 with a supporting element configured as a positioning pin 154 and FIG. 6b displays the charging station 100 displayed in FIG. 6a, on which a hair clipper 300 is stored. The positioning pin 154 arranged in the connection device 120 supports the hair clipper 300 in such a way that—unlike the configuration displayed in FIG. 5b—no leaning element 152 is required.

FIG. 6c displays a charging station 100 similar to the charging station 100 displayed in FIG. 6a, with a retaining element 140 configured as a ring magnet. The ring magnet can be configured in such a way that it exerts a magnetically repulsive effect on a retaining element arranged in a connection device of a hair clipper. Thus, positioning and support of the hair clipper is achieved. Furthermore, the ring magnet of the charging station 100 can also be configured in such a way that it exerts a magnetically attractive effect on a retaining element arranged in a connection device of a hair clipper, thus achieving positioning and support of the hair clipper.

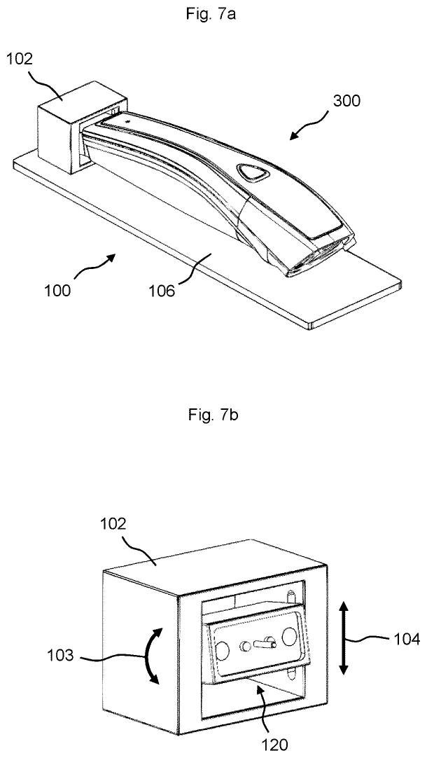

FIG. 7a displays a combination of a charging station 100 comprising a connection housing 102, into which a connection device 120 is integrated, and a hair clipper 300 stored on a bearing area 106. FIG. 7b displays the connection housing 102 and the integrated connection device 120 of the charging station 100 displayed in FIG. 7a. With the embodiment displayed, the charging station 100 can be used for hair clippers 300 with different housing geometry—different distances between the connection devices of the hair clippers 300 to the bearing area 106 as well as different angular orientations of the connection devices of the hair clippers 300 to the bearing area 106 in the state of the stored hair clipper 300—by positioning the connection device 120 of the charging station 100 according to the required angular orientation and the required distance. For this purpose, the connection device 120 can be moved linearly upwards or downwards along the straight arrow 104 and rotated clockwise and counterclockwise along the arrow 103.

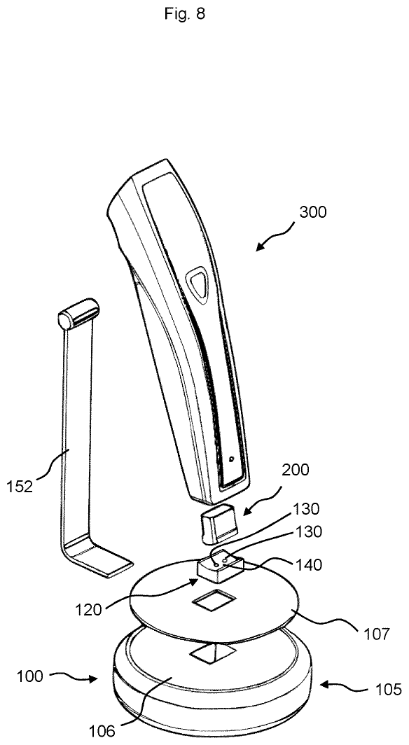

FIG. 8 displays an exploded view of a combination of a hair clipper 300, an adapter 200 and a charging station 100 comprising a cover plate 107. The adapter 200 is configured to adapt a plug contact of the hair clipper 300 and comprises a main body with a plug device configured to plug the adapter 200 to a connection device of the hair clipper 300. The adapter 200 further comprises a connection device 220 with projection 224—as displayed for example in FIGS. 1a, 1d, 2a, 2c, 3a—which can be brought into contact with a connection device 120 of the charging station 100.

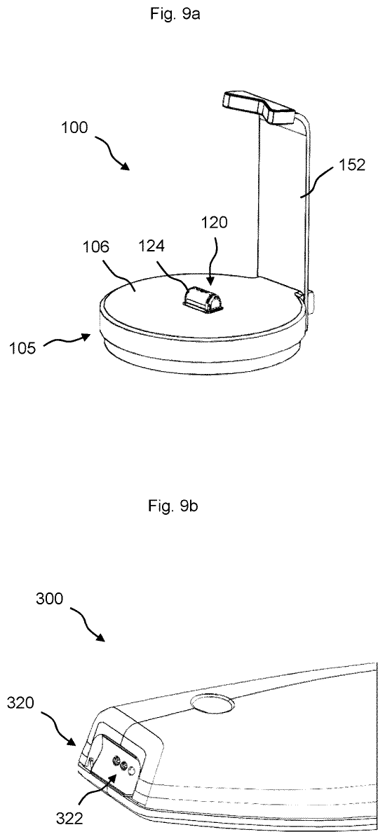

FIG. 9a displays a charging station 100 with a connection device 120 comprising a projection 124 and FIG. 9b displays a lower part of a hair clipper 300 usable with the charging station 100 displayed in FIG. 9a, with a connection device 320 having a recess 322. The charging station 100 also has a main body 105, which also has a bearing area 106. Compared to the bearing area 106 displayed in FIG. 8, the bearing area 106 is configured in such a way that it overlaps the upper side of the remaining main body 105. Compared to the combination of a hair clipper 300 and a charging station 100 displayed in FIG. 5b, when using the charging station 100 displayed in FIG. 9a in combination with the hair clipper 300 displayed in FIG. 9b, the bearing area 106 does not have to be tilted, but the connection device 120 of the charging station 100 is pivoted against the connection device 320 of the hair clipper 300—see, for example, the pivoted state of two connection devices 120, 220, 320 shown in FIG. 1c. Thus, the hair clipper 300 is supported by the leaning element 152.

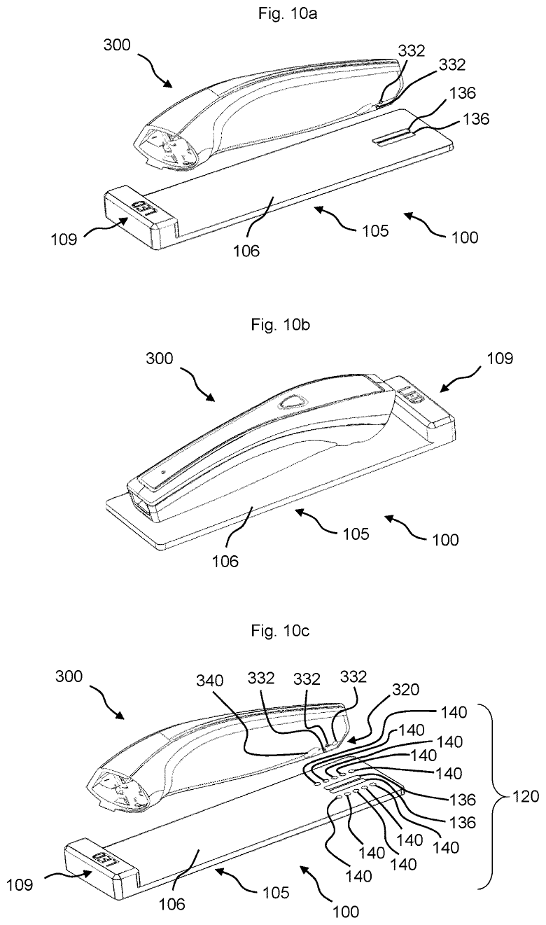

FIG. 10a displays a combination of a hair clipper 300 with two contact elements configured as contact projections 332 and a charging station 100 with two contact elements configured as contact strips 136 and a status display 109 in the state immediately before the hair clipper 300 is stored. FIG. 10b displays the combination of a hair clipper 300 and a charging station 100 displayed in FIG. 10a in the state of the stored hair clipper 300.

FIG. 10c displays a combination of a hair clipper 300 and a charging station 100 similar to the combination of a hair clipper 300 and a charging station 100 displayed in FIGS. 10a and 10b, comprising a plurality of retaining elements 140 positioned adjacent to the contact strip 136 of the charging station 100 and acting to magnetically repel the retaining elements 340 of the hair clipper 300. Here, two rows of five retaining elements 140 arranged one above the other are displayed. Thus, the connection device 320 of the hair clipper 300 is centred between the two rows of retaining elements 140, which also positions the contact projections 332 on the contact strip 136 of the charging station 100 in such a way that an electrical contact results between the contact projections 332 and the contact strip 136. If the connection device 320 of the hair clipper 300 is correctly aligned with the connection device 120 of the charging station 100, this can be indicated via the status display 109. Furthermore, the status display 109 can be configured in such a way that the charging state of the battery device of the hair clipper 300 can be displayed.

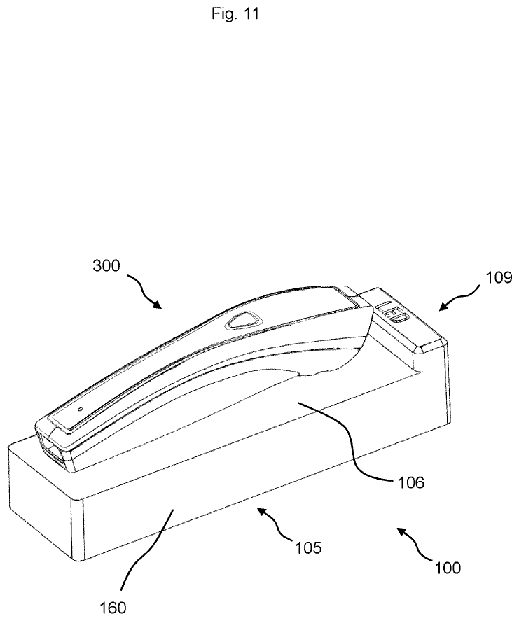

FIG. 11 displays a combination of a hair clipper 300 and a charging station 100 with a status display 109 and a battery device 160. The main body 105 is much more voluminous than the main body 105 displayed in FIGS. 10a to 10c, so that there is sufficient space for the battery device 106 arranged in the main body 105.

### REFERENCE SIGNS LIST

100 charging station
102 connection housing
103 arrow
104 straight arrow
105 main body
106 bearing area
107 cover plate
109 status display
120 connection device
122 recess
124 projection
130 contact element
132 contact projection
136 contact strip
140 retaining element
152 leaning element
154 positioning pin
160 battery device
200 adapter
220 connection device
222 recess
224 projection
226 positioning recess
230 contact element
232 contact projection
236 contact strip
240 retaining element
300 Hair clipper
320 connection device
322 recess
324 projection
326 positioning recess
330 contact element
332 contact projection
336 contact strip
340 retaining element

1. A charging station for charging a battery device in a hair clipper, comprising:
a main body;
a connection device for electrically connecting the hair clipper to the charging station; and
the connection device has two contact elements and a magnetic retaining element.

2. The charging station according to claim 1, further comprising at least one supporting element for supporting the hair clipper.

3. The charging station according to claim 1, further comprising a battery device.

4. An adapter for adapting of a plug contact of a hair clipper, comprising:
a main body with a plug device, configured to connect the adapter to a connection device of a hair clipper;
a connection device, which can be contacted with a connection device of a charging station; and
the connection device comprises two contact elements and a magnetic retaining element.

5. A hair clipper comprising:
a blade arrangement for cutting;
a drive unit, which drives the blade arrangement;
a battery device, which supplies electrical power to the drive unit;
a connection device, which is electrically connected to the battery device and which can be contacted to the connection device of a charging station for charging the battery device; and
the connection device comprises two contact elements and a magnetic retaining element.

6. The charging station according to claim 1, wherein the connection device comprises an inwardly curved recess or an outwardly curved projection.

7. The charging station according to claim 6, wherein the two contact elements together with the at least one retaining element completely cover the recess or the projection.

8. The charging station according to claim 1, wherein at least one of the two contact elements is configured as a contact projection, a contact recess and/or a contact strip.

9. The charging station according to claim 1, comprising at least two retaining elements being, in particular magnetically oppositely polarised.

10. The charging station according to claim 1, wherein at least one of the two contact elements is configured as magnetic retaining element or the retaining element is positioned adjacent to the contact element.

11. The charging station according to claim 1, wherein the at least one retaining element and/or the two contact elements comprise/s a round, in particular circular, or striped contact area.

12. The charging station according to claim 1, wherein the contact elements are configured with different form-fit.

13. A combination of a charging station according to claim 1 and a hair clipper or a hair clipper comprising an adapter, wherein both the charging station and the hair clipper have connection devices which are configured complementary to one another with respect to the magnetic retaining elements.

14. The adapter of claim 4, wherein the connection device comprises an inwardly curved recess or an outwardly curved projection, and wherein the two contact elements together with the at least one retaining element completely cover the recess or the projection.

15. The hair clipper according to claim 5, wherein the connection device comprises an inwardly curved recess or an outwardly curved projection, and wherein the two contact elements together with the at least one retaining element completely cover the recess or the projection.

16. The adapter according to claim 4, wherein at least one of the two contact elements is configured as a contact projection, a contact recess and/or a contact strip.

17. The hair clipper of claim 5, wherein at least one of the two contact elements is configured as a contact projection, a contact recess and/or a contact strip.

18. The adapter according to claim 4, comprising at least two retaining elements being, in particular magnetically oppositely polarised.

19. The hair clipper according to claim 5, comprising at least two retaining elements being, in particular magnetically oppositely polarised.

20. The hair clipper according to claim 5, wherein at least one of the two contact elements is configured as magnetic retaining element or the retaining element is positioned adjacent to the contact element.
